(19) United States
(12) Patent Application Publication
(10) Pub. No.: US 2019/0039937 A1
(43) Pub. Date: Feb. 7, 2019

(54) THERMALLY STRENGTHENED GLASS SHEETS HAVING CHARACTERISTIC NEAR-EDGE RETARDANCE

(71) Applicant: Corning Incorporated

(72) Inventors: Ravindra Kumar Akarapu, Horseheads, NY (US); Jeffrey John Domey, Elmira, NY (US); William John Furnas, Elmira, NY (US); Anurag Jain, Painted Post, NY (US); John Christopher Thomas, Elmira, NY (US)

(21) Appl. No.: 16/073,940

(22) PCT Filed: Jan. 31, 2017
(86) PCT No.: PCT/US2017/015729

§ 371 Date: Jul. 30, 2018

Related U.S. Application Data
(60) Provisional application No. 62/289,334, filed on Jan. 31, 2016.
(60) Provisional application No. 62/428,530, filed on Nov. 30, 2016.

(51) Int. Cl. C03B 27/016; C03C 23/00; C03B 35/24; C03B 27/048

(52) U.S. Cl. CPC C03B 27/016; C03B 27/048; C03B 35/24; C03C 23/007

(57) ABSTRACT

A strengthened glass or glass ceramic sheet has a first major surface, a second major surface opposite the first major surface, an interior region between the first and second surfaces, an outer edge surface extending between the first and second major surfaces, and a thickness between the first major surface and the second major surfaces, wherein the sheet comprises a glass or glass ceramic and is thermally strengthened and wherein the first major surface has a roughness of more than 0.1 nm Ra and less than 500 nm Ra over an area of 10 μm×10 μm and wherein PP<0.05·(LL), where LL is the maximum differential optical retardation with a slow axis closer to perpendicular than to parallel to the outer edge of the sheet, measured through the sheet through the first and second major surfaces of the sheet at a measurement location on the first surface of the sheet, as the measurement location moves inward from a point at the outer edge of the sheet, to a point three times the thickness from the outer edge, and where PP is the maximum differential optical retardation with a slow axis closer to parallel than to perpendicular to the outer edge of the sheet, measured through the sheet through the first and second major surfaces of the sheet, at the measurement location as the measurement location moves inward from the point at the outer edge of the sheet, to a point three times the thickness from the outer edge.

This application claims the benefit of priority of U.S. Provisional Application No 62/289,334, filed on Jan. 31, 2016, and U.S. Provisional Application No 62/428,530, filed on Nov. 30, 2016, the contents of which are relied upon and incorporated herein by reference in their entirety.

This application is related to and hereby incorporates herein by reference in full the following applications: Provisional Application Ser. No. 62/288,851, filed on Jan. 29, 2016, U.S. application Ser. No. 14/814,232, filed on Jul. 30, 2015; U.S. application Ser. No. 14/814,181, filed on Jul. 30, 2015; U.S. application Ser. No. 14/814,274, filed on Jul. 30, 2015; U.S. application Ser. No. 14/814,293, filed on Jul. 30, 2015; U.S. application Ser. No. 14/814,303, filed on Jul. 30, 2015; U.S. application Ser. No. 14/814,363, filed on Jul. 30, 2015; U.S. application Ser. No. 14/814,319, filed on Jul. 30, 2015; U.S. application Ser. No. 14/814,335, filed on Jul. 30, 2015; U.S. Provisional Application No. 62/031,856, filed Jul. 31, 2014; U.S. Provisional Application No. 62/074,838, filed Nov. 4, 2014; U.S. Provisional Application No. 62/031,856, filed Apr. 14, 2015; U.S. application Ser. No. 14/814,232, filed Jul. 30, 2015; U.S. application Ser. No. 14/814,181, filed Jul. 30, 2015; U.S. application Ser. No. 14/814,274, filed Jul. 30, 2015; U.S. application Ser. No. 14/814,293, filed Jul. 30, 2015; U.S. application Ser. No. 14/814,303, filed Jul. 30, 2015; U.S. application Ser. No. 14/814,363, filed Jul. 30, 2015; U.S. application Ser. No. 14/814,319, filed Jul. 30, 2015; U.S. application Ser. No. 14/814,335, filed Jul. 30, 2015; U.S. Provisional Application No. 62/236,296, filed Oct. 2, 2015; U.S. Provisional Application No. 62/288,549, filed Jan. 29, 2016; U.S. Provisional Application No. 62/288,566, filed Jan. 29, 2016; U.S. Provisional Application No. 62/288,615, filed Jan. 29, 2016; U.S. Provisional Application No. 62/288,695, filed on Jan. 29, 2016; U.S. Provisional Application No. 62/288,755, filed on Jan. 29, 2016.

### FIELD

This application relates generally to improved thermally tempered glass, and related methods and apparatuses for producing such, more specifically methods and apparatuses for heat transfer to and/or from a glass sheet, desirably at high rates, without inducing excessive inhomogeneity or roughness or other unwanted properties, while producing good edge strength properties evidenced by a characteristic near-edge retardance through the sheet.

### BACKGROUND

Commonly-assigned U.S. Pat. No. 9,296,638 (the '638 patent) entitled “Thermally Tempered Glass and Method and Apparatuses for Thermal Tempering of Glass” discloses methods and apparatuses for heating and/or thermally tempering glass sheets. The contents of the '638 patent are relied upon and incorporated herein by reference in their entirety for purposes of U.S. law.

### DEFINITIONS

The phrases “glass sheet(s)” and “glass ribbon(s)” are used broadly in the specification and in the claims and include sheet(s) and ribbon(s) that comprise one or more glasses and/or one or more glass-ceramics, as well as laminates or other composites that include one or more glass and/or one or more glass-ceramic components. The phrase “glass sheet(s)” is used to refer to glass sheet(s) and glass ribbon(s) collectively. “Glass” includes glass and materials known as glass ceramics.

### SUMMARY

The present disclosure provides additional features or enhancements relative to the methods and apparatuses for the production of thermally tempered glass of the'232, '851, and '856 applications which, together with the methods and apparatuses of the said applications provide for the production of thermally strengthened glass sheets having improved properties, in particular, improved edge strength evidenced by a characteristic near-edge retardance profile.

According to embodiments, a strengthened glass sheet is provided, the sheet comprising a first major surface, a second major surface opposite the first major surface, an interior region located between the first and second major surfaces, an outer edge surface extending between and surrounding the first and second major surfaces such that the outer edge surface defines the perimeter of the sheet, and a thickness defined as the local distance between the first major surface and the second major surface of the sheet. The first major surface of the sheet has a roughness in the range of from 0.05 to 0.8 nm Ra over an area of 10 μm×10 μm. The sheet also satisfies PP<0.05·(LL), where LL is defined as the maximum differential optical retardation with a slow axis closer to perpendicular than to parallel to the outer edge of the sheet and PP is defined as the maximum differential optical retardation with a slow axis closer to parallel than to perpendicular to the outer edge of the sheet, if any, otherwise zero, with both PP and LL measured through the sheet through the first and second major surfaces beginning at a location 3 thicknesses of the sheet distant from the outer edge surface of the sheet and moving by steps 1/100 of the thickness of the sheet to the outer edge surface of the sheet, with the value of LL including an extrapolation of the maximum retardation at the outer edge surface of the sheet as provided in ASTM C1279.

According to embodiments, PP may be less than 0.03·(LL), 0.02·(LL), 0.01·(LL), or even less than 0.001·(LL). Of course, PP may also be zero.

According to further embodiments compatible with any of the above embodiments, Ra roughness, measured over an area on the first major surface of 10 μm×10 μm according to the standard of ISO 19606, can be in the range of from 0.05 or 0.1 nm to 20, 4, 0.8, 0.7, 0.6, 0.5, 0.4, 0.3 or even as low as to 0.2 nm Ra.

According to still further embodiments compatible with any of the above embodiments, the thickness of the sheet may be within in the range of from 0.1, 0.2 or 0.5 mm to 3, 2.8, 2.6, 2.4, 2.2, 2.0, 1.8, 1.6, 1.4, 1.2, 1.1, 1, 0.9, 0.8, 0.7, and even 0.6 mm. One material of the sheet may be soda lime glass.

The reference characters used are only for the convenience of the reader and are not intended to and should not be interpreted as limiting the scope of the invention. More generally, it is to be understood that both the foregoing general description and the following detailed description are merely exemplary of the invention and are intended to provide an overview or framework for understanding the nature and character of the invention.

Additional features and advantages of the invention are set forth in the detailed description which follows, and in part will be readily apparent to those skilled in the art from that description or recognized by practicing the invention as exemplified by the description herein. The accompanying drawings are included to provide a further understanding of the invention, and are incorporated in and constitute a part of this specification. It is to be understood that the various features of the invention disclosed in this specification and in the drawings (which are not to scale) can be used individually and in any and all combinations.

### BRIEF DESCRIPTION OF THE DRAWINGS

FIG. 1 is a schematic cross sectional side view drawing of an embodiment of a heat sink or source for heating or cooling a glass sheet.

FIG. 2 is a schematic cross sectional side view drawing of an embodiment of an apparatus for heating and then quenching glass sheets.

FIG. 3 is a schematic cross-sectional plan view drawing of an embodiment of a heat source.

FIG. 4 is a perspective view drawing of a sheet or sheet comprising glass.

FIG. 5 is a schematic cross sectional side view drawing of an embodiment of a heat sink or source.

FIG. 6 is a schematic cross sectional side view drawing of another embodiment of a heat sink or source.

FIG. 7 is a diagrammatic cross-sectional illustration of gas flow relative to a sheet believed to be produced during the operation conventional forced gas convection tempering processes.

FIGS. 8A and 8B are diagrammatic cross-sectional illustrations of gas flow relative to a sheet believed to be produced during the operation of two different embodiments of heat sinks as described herein.

FIG. 9 is a transparent perspective view diagram of a glass sheet showing a cross section used in simulation calculations for of stresses produced in the sheet by thermal tempering.

FIG. 10 is a graph of certain edge stresses produced in a glass sheet under varying edge cooling rates relative to the major surface cooling rate, as calculated by tempering process simulation, at the location shown in FIG. 9.

FIG. 11 is a transparent perspective view diagram of a glass sheet showing a cross section used in simulation calculations of edge retardance profiles through the thickness of the sheet.

FIG. 12 is a graph of simulation results for edge retardance profiles through the thickness of a glass sheet as a function of distance in a direction parallel to the edge for various edge heat transfer rates during quenching.

FIG. 13 is a graph of measured edge retardance profiles through the thickness of a glass sheet as a function of distance in a direction parallel to the edge for a glass sheet according to the present disclosure, tempered using a porous gas bearing, and for comparative glass sheets tempered by forced air convection.

FIG. 14 is a graph of measured edge retardance profiles through the thickness of a glass sheet as a function of distance in a direction parallel to the edge for a glass sheet according to the present disclosure, tempered using a discrete hole gas bearing, and for comparative glass sheets tempered by forced air convection.

### DETAILED DESCRIPTION

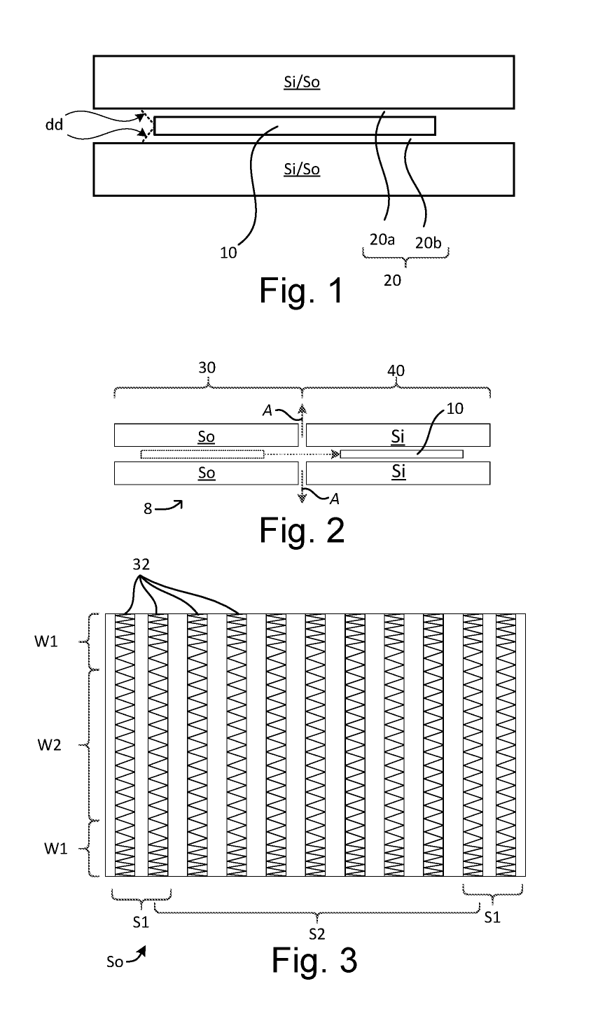

FIG. 1 is a schematic cross sectional side view drawing of an embodiment of an arrangement of a pair of heat sinks or sources Si/So for heating or cooling a glass sheet 10. Thin gaps 20 between the sheet 10 and the heat sinks or sources Si/So contain a gas through which heat is conducted to heat or cool the sheet 10 such that at least 20% of the total heating or cooling is by conduction, desirably 30, 40, 50, 60, and even 70, 80 or 90% or more. The sheet 10 is supported between the two sinks or sources Si/So by any suitable and most preferably non-contact means, including such alternatives as ultrasonic energy, electrostatic forces, but preferably by gas bearings formed in the gaps 20 (comprising first gap 20a and second gap 20b).

The sheet 10 can be stationary or in motion between the sinks or sources Si/So. The sheet 10 can be smaller (in one dimension or both) than the extent of the sinks or sources Si/So or larger (preferably in one dimension only, in which case continuous processing in the larger direction is preferred). The sheet 10 can be multiple sheets heated or cooled together at the same time. The gas in the first and second gaps 20a and 20b can be the same or different, and both or either can be gas mixtures or essentially pure gases. Generally, gases or gas mixtures with relatively higher thermal conductivity are preferred. Use of gas bearings allows robustly maintaining the desired size of the gaps 20a and 20b, which enables relatively homogeneous heat transfer rates over all areas of the gaps 20, in comparison to cooling or heating by direct contact with liquids or with solids, and in comparison to cooling by forced air convection.

As represented in the diagrammatic cross section of FIG. 2, a thermal tempering or strengthening apparatus 8 generally includes both a heating zone 30 and a cooling zone 40, and both can be in the form of a pair of heat sources So or a pair of heat sinks Si, separated from the sheet by thin gas gaps 20 as in FIG. 1. As an alternative, the heating zone may be in the form of a conventional furnace or oven rather than the thin-gap arrangement of heat sources So shown here. In general terms, heating zone 30 heats the glass sheet(s) to a temperature sufficient for thermal strengthening, and the cooling zone 40 lowers the temperature of the sheet(s) by removing heat through the surfaces of the sheet(s) at a rate sufficient and for a sufficient time to achieve a desired level of thermal strengthening when the sheet(s) are (later) finally at ambient temperatures. A sheet 10 is heated to a sufficient temperature for generating temper effects (generally between the glass transition point and the softening point of the glass), and is cooled in the cooling zone. Transport may be by any suitable means.

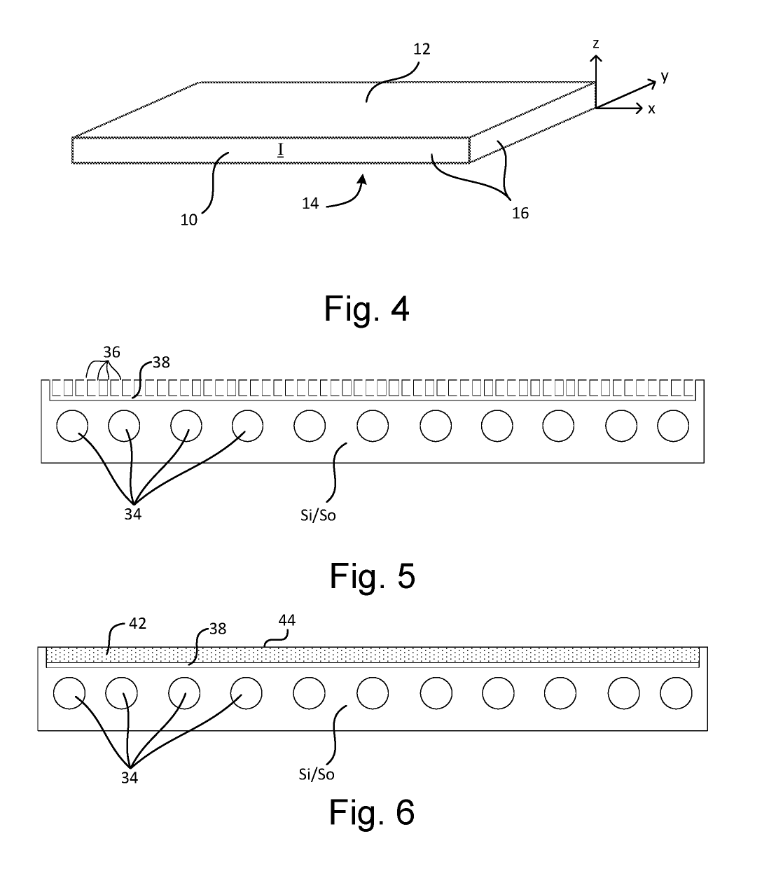

FIG. 4 shows a perspective view of the sheet 10 comprising glass, which includes a first major surface 12, a second major surface 14 opposite the first (obscured in the view of FIG. 3), an interior region I located between the first and second major surfaces, and an outer edge surface 16 extending between and surrounding the first and second major surfaces such that the outer edge surface defines the perimeter of the sheet. x-y-z coordinates are shown for ease of reference, with z in the thickness direction.

Gas bearings, as alternative embodiments, may take either of the forms shown in FIGS. 5 and 6. FIG. 5 is a schematic cross sectional side view drawing of one embodiment of a heat sink or source Si/So, and FIG. 6 is a schematic cross sectional side view drawing of another embodiment of a heat sink or source Si/So. In both of these embodiments, the circular structures are thermal control structures 34, such as cartridge heaters if the embodiment is a heat source So, or such as coolant passages if the embodiment is a heat sink Si. The embodiment of FIG. 5 employs discrete holes 36 through which gas can be fed from a plenum 38. The embodiment of FIG. 6 includes a porous structure 42 through which gas can likewise be fed from a plenum 38, with the effect that the gas is emitted essentially from every portion of the surface 44 of the porous structure 42.

Because of the non-contact treatment and handling possible in the thermal strengthening apparatus of FIG. 2, by using gas bearings such as in FIGS. 5 and 6 or by other suitable non-contact means, the first major surface 12 of the sheet 10 can have very low roughness, achieved by preserving the as-floated quality of the “air side” of float glass, or the as-drawn quality of either side of fusion-drawn glass. The Ra roughness, measured over an area on the first major surface of 10 μm×10 μm according to the standard of ISO 19606, can be in the range of from 0.05 or 0.1 nm to 20, 4, 0.8, 0.7, 0.6, 0.5, 0.4, 0.3 or even as low as to 0.2 nm Ra. The self-restoring or self-centering effects of opposing gas bearings can also assist in keeping thin glass sheets flat, even very thin sheets. Thin sheets with thicknesses within in the range of from 0.1, 0.2 or 0.5 mm to 3, 2.8, 2.6, 2.4, 2.2, 2.0, 1.8, 1.6, 1.4, 1.2, 1.1, 1, 0.9, 0.8, 0.7, 0.6 mm can be processed, as well as thicker sheets.

Achieving uniformity of cooling effects in the cooling zone 40 over the area of the sheet 10 requires maintaining the desired size of the gaps 20. It has also been found that maintaining the homogeneity of the gas in the gaps 20a, 20b within the cooling zone is important. If different gases are used in the heat source So gaps and the heat sink Si gaps, gas can be drawn away by a suitable suction or vacuum means at a position between the sources So and the sinks Si, as indicated by the arrows A in FIG. 2, so that the differing gases do not mix within the heat sinks Si of the cooling zone (or within the heat sources So). Alternatively and optionally, a transition zone such as is disclosed in the '638 patent, positioned between the heating and cooling zone, can include a feed of the same gas as in the cooling zone and can physically isolate the heating zone gas from the cooling zone gas in the case that they are different. Interestingly, and in contrast to forced convective gas tempering, when the gases are the same and conduction is the dominating heat transfer mode, any hot gas traveling with the sheet 10 from hot zone 30 to cold zone 40 is not a very significant factor in the process, since the thermal mass of the gas is negligible relative to the effects of conduction.

For good homogeneity of heat transfer rates during heating and resulting homogeneous temperature profiles and final properties of sheet 10, it is also desirable to provide a heat source So providing for a non-uniform distribution of heating energy. FIG. 3 shows diagrammatic cross sectional plan view of a heat source So such as those of FIGS. 1 and 2, having such a non-uniform distribution of heating energy in the form of cartridge heaters 32 distributed within the heat source So. A first spacing S1 of the cartridge heaters near the left and right edges of the heat source So in the figure is closer than a second spacing S2 of the cartridge heaters in the more central region of the heat source So. This has the effect, desired in most circumstances, of balancing thermal losses to the ambient environment at the left and right edges of the heat source So. Similarly, the windings within the cartridge heaters 32 can have a first average winding density W1 near the edges (top and bottom in the figure) of the heat source So greater than a second average winding density W2 in the more central region of the heat source So.

With good control of the thermal profile of the sheet just before cooling, such as may be achieved by the heat source So of FIG. 3 or by other suitable means, and with steps taken to prevent unwanted gas mixing in the heat sink Si, as described in connection with FIG. 2 or by other suitable means, thermally strengthened sheets comprising glass and/or glass ceramic can be produced having very good quality, especially relative to the achieved strengthening as a function of glass thickness and glass properties. In particular, the improved properties can include, but are not limited to, high uniformity of parameters produced or affected by thermal strengthening.

For example, a sheet processed according to this disclosure in combination with the disclosure of the '638 patent can achieve a desirable low deviation of membrane stress, through-thickness optical retardation, such that a normalized standard deviation Sₙ

$${S}_{n} = \frac{s}{\overline{x}} \qquad ( 1 )$$

of a sample of membrane stress or through-thickness retardation measurement samples taken using according to ASTM F218, in transmission through the first major surface 12 of the sheet 10 in a series distributed in the x and y directions for number of samples N=100, is low (when measurements too close, i.e., within 3 times the thickness of the sheet to the outer edge surface, 16 are not included)—as low as 0.02, 0.015, 0.01, 0.005, 0.002, 0.001 or even lower.

Improved properties also include high edge strength, as evidenced by a characteristic edge stress retardation profile.

Edge Strength and Edge Stress Retardation Profiles

Edge strength of sheets according to the present disclosure has been found to be improved relative to sheets strengthened using conventional forced air convective cooling. This is somewhat surprising, given the relatively very low flow of gas used in the apparatus 8 of FIG. 2 and similar apparatuses as disclosed in the '638 patent. That edge strength is improved has been found to be the case in part through simulations of both tempering of samples and of the resulting optical retardation produced in the samples.

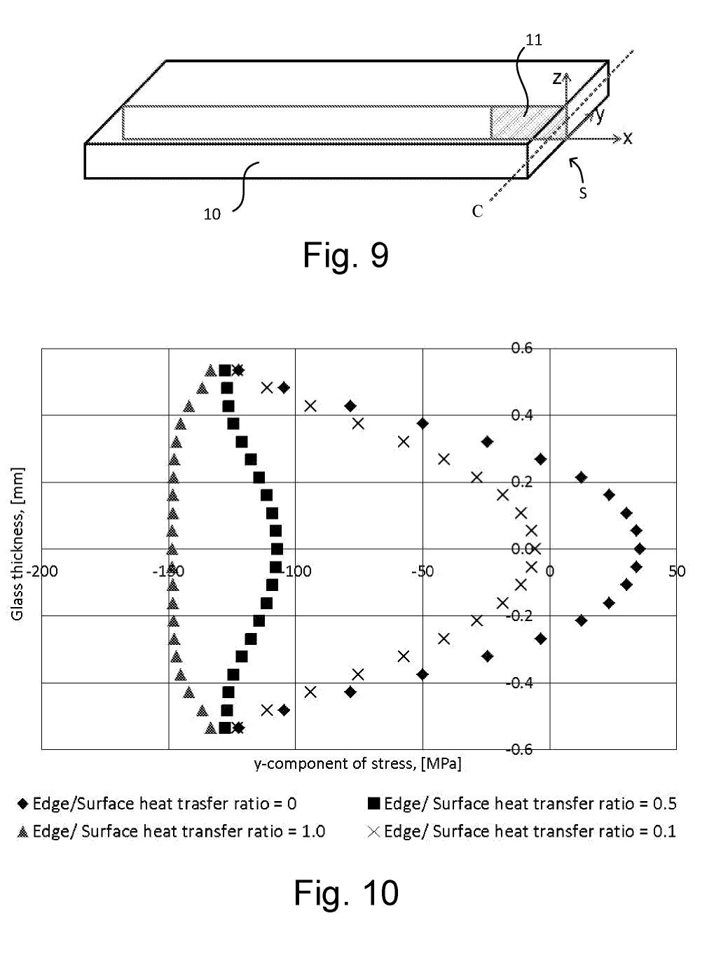

FIG. 9 is a transparent perspective view diagram of a glass sheet 10 for which thermal tempering processes were simulated using ANSYS tempering simulation software. Tempering of a 114 mm long by 58 mm wide and 1.1 mm thick sheet was simulated, for four conditions with zero, then increasing levels of cooling at the outer edge surface, namely, with the outer-edge-surface to major-surface heat transfer coefficient ratio equal to 0, 0.1, 0.5, and finally 1.0, and with the major-surface heat transfer coefficient set to 2512 W/m²° K. Stress post-processing was then performed on the shaded region 11 to establish the expected resulting temper stresses. The resulting calculated stress in the y axis direction of FIG. 9, calculated at a point that moves along the z axis direction (the thickness direction) of the outer edge surface (i.e., along the right most edge of the shaded region 11 of FIG. 9) is graphed in FIG. 10, for each of the four ratios 0, 0.1, 0.5, and 1.0.

With reference to FIGS. 9 and 10, as may be seen from the graph of FIG. 10, with zero cooling simulated at the outer edge surface of the sheet 10, a region of the outer edge surface at and near the centerline C of the sheet (centered between the two major surfaces) is in tension in the y-vector direction (positive values in the graph) rather than in compression. With 10% as much cooling simulated at the outer edge surface as on the major surfaces, in the position simulated at center of side S of the outer edge surface of the sheet 10, the centerline C of the outer edge surface is only barely in compression (in the y-vector direction), at about 5-7 MPa. Much more satisfactory results are seen for the ratios of 0.5 and 1, where the center of the outer edge surface ranges in compression (in the y-vector direction) from over 100 MPa to nearly 150 MPa. Unfortunately tension and/or compression in the y-vector direction at centerline C of the outer edge surface of the sheet 10 is somewhat difficult to measure directly.

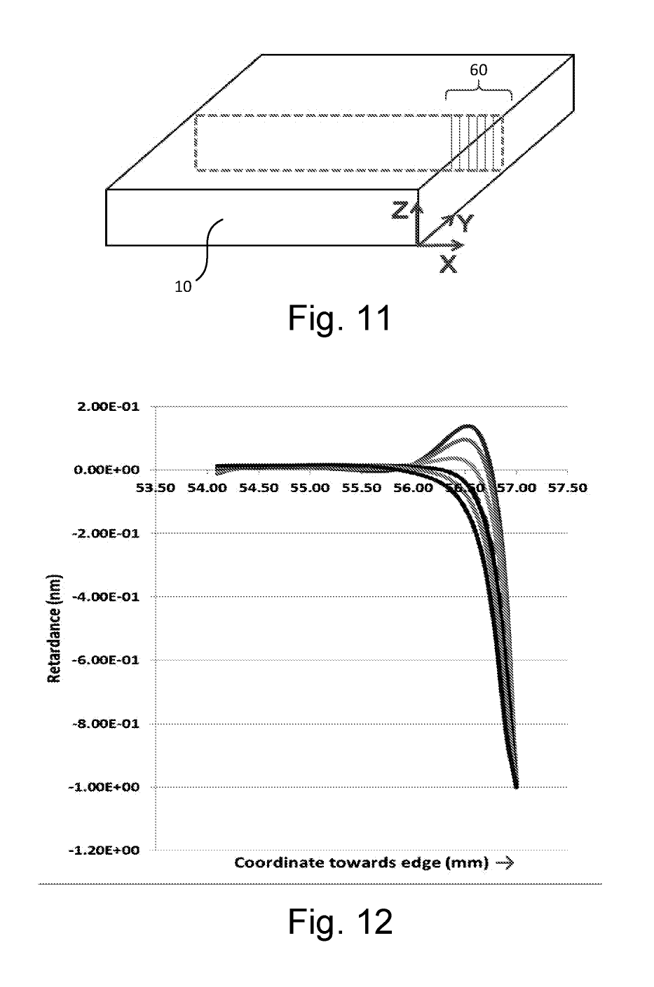

A corresponding simulation was performed, again for various rates of heat transfer at the outer edge surface of a sheet, and the resulting stress distribution calculated for a relevant portion of the sheet. The resulting optical retardance was then calculated, through the thickness of the sheet 10 (in the z-axis direction), beginning at a distance at least 3 times the thickness of the sheet from the edge of the sheet, then progressing up to the edge, in other words, along optical paths represented by the parallel lines 60 of FIG. 11. FIG. 12 is a graph of the calculated retardance, with negative values shown where the slow axis is perpendicular (or more nearly perpendicular than parallel) to the edge being approached, and positive values shown where the slow axis is parallel (or more nearly parallel than perpendicular) to the edge being approached. Such graphs are sometimes known as Edge Retardance Profiles or ERPs, and are measured (but not interpreted) according to ASTM C1279 procedure B (edge stress measurement) for purposes of this application, with measurement points as specified herein—namely points spaced at 1/100 the sheet thickness starting from three sheet thickness distant from the outer edge surface and moving to the outer edge surface. The simulated ERPs in shown in FIG. 12 are for edge heat transfer rates, in order in the figure from the most-peaked curve to the least, of 0, 50, 250, 640, 1250, 2500, and 5000 W/m²° K, each with a major surface heat transfer rate of 2512 W/m²° K W/m²° K, thus corresponding to major-surface to outer-edge-surface ratios of about 0, 0.02, 0.10, 0.25, 0.50, 1.0, and 2.0, respectively. (The 0.25 and 0.5 traces overlap significantly, with the 0.25 shown by a dashed line and the 0.50 shown by a solid line.)

As can be seen from FIG. 12, the lower the rate of outer edge surface cooling, the higher the positive peaks, or the tendency toward positive peaks, (representing higher maximum retardation where the slow axis is parallel to the edge) and the higher the outer edge surface cooling, the greater the tendency to a lower height or even non-existent positive peak.

As may be seen by comparison and correlation of the simulation results in FIGS. 10 and 12, ERPs thus offer a non-destructive way to gauge the strengthening of the edge, particularly at the centerline C of the outer edge surface 16 of the sheet 10. This is contrary to the current understanding of the state of the art, according to which the essentially identical lowest negative values at the far right of FIG. 12 are believed to represent essentially identical levels of edge strength. This is apparently not the case, at least for edge strength in the y direction at the centerline of the outer surface of the sheet.

Surprisingly, ERPs measured on glass sheet samples produced according to the methods of the present disclosure evidence greater edge strength (they show less tendency toward positive peaks, representing higher maximum retardation where the slow axis is parallel to the edge) than ERPs measured on glass sheet samples produced by conventional convective tempering methods.

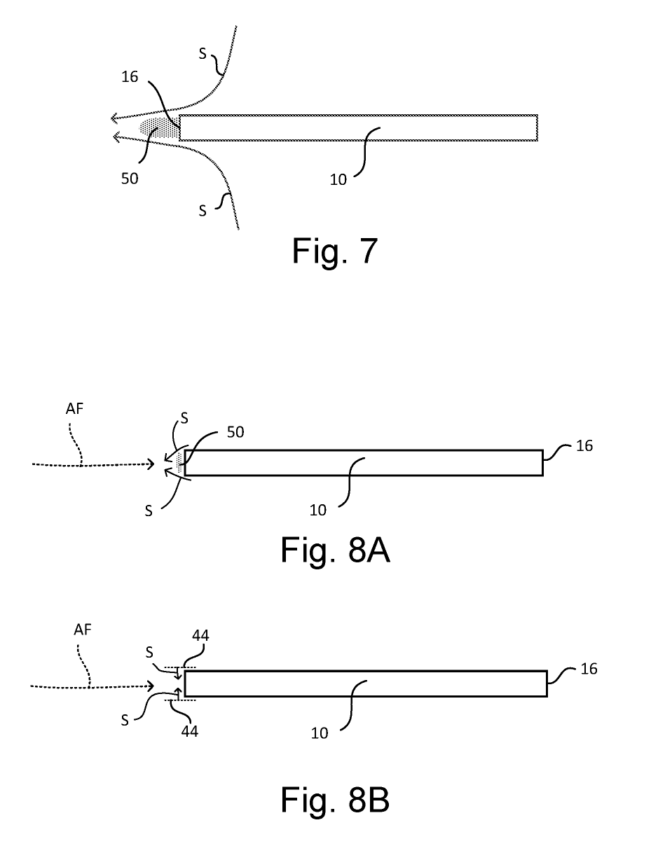

The theoretical discussion in this paragraph is not to be regarded as binding on the scope of invention or claims relative to this disclosure, however, the following is offered as consistent with the current understanding of the inventors. Specifically, FIG. 7 represents gas flow streams S believed to be consistent with known forced air convective thermal tempering of glass. Very large air flows must generally be used to produce high strength or to produce strength in relatively thin glass. The high air flows used result in high velocity streams leaving the major surfaces of a sheet or sheet 10 under treatment, with a resulting zone of low flow 50 (or even partial vacuum) created a the outer edge surface 16 of the sheet 10 between the flow streams S, resulting in low heat transfer rates at the outer edge surface 16 during cooling of the sheet 10. FIG. 8A shows gas flow streams S believed to be consistent with cooling of a glass sheet 10 using a discrete-hole heat sink embodiment such as the one represented in FIG. 5. The streams S have significantly lower volume and velocity and produce a much smaller zone of low flow 50, resulting in improved heat transfer rates at the outer edge surface 16 during cooling of the sheet 10 relative to forced air convective cooling. FIG. 8B shows gas flow streams S believed to be consistent with cooling of a glass sheet 10 using a porous structure heat sink embodiment such as the one represented in FIG. 6. Streams S flow from essentially every location of the surface 44 of the porous structure, resulting in no or little zone of low flow the outer edge surface 16 and improved heat transfer rates at the outer edge surface 16 during cooling of the sheet 10, even relative to cooling using a discrete-hole heat sink. In addition to the above effects, use of thin-gas-gap heat sinks allows the optional use of an auxiliary gas flow AF directed at the outer edge surface 16 during cooling of the sheet 10. Because the gas flow rates needed for the major surfaces 12, 14, of the sheet 10 can be very low, auxiliary gas flow AF can reach and affect the outer edge surface 16 beneficially to a significant degree, providing increased heat transfer rates there. Further, in the methods of the present disclosure and '638 patent, cooling of a glass sheet for strengthening purpose takes place predominantly by conduction across a gas gap of relatively small dimension, such as in the range of from 20 to 300 μm. With such small gaps used between the sheet or sheet under cooling and the heat sinks Si, and when glass sheets of bout 3 mm or 2 mm and below are processed, the distance dd shown in FIG. 1 between the sheet outer edge surface and the surface of the heat sinks Si also becomes relatively small. This is believed to be the principle factor, but for all or some of these reasons, edge strength is enhanced relative to standard convective tempering or strengthening of glass sheets.

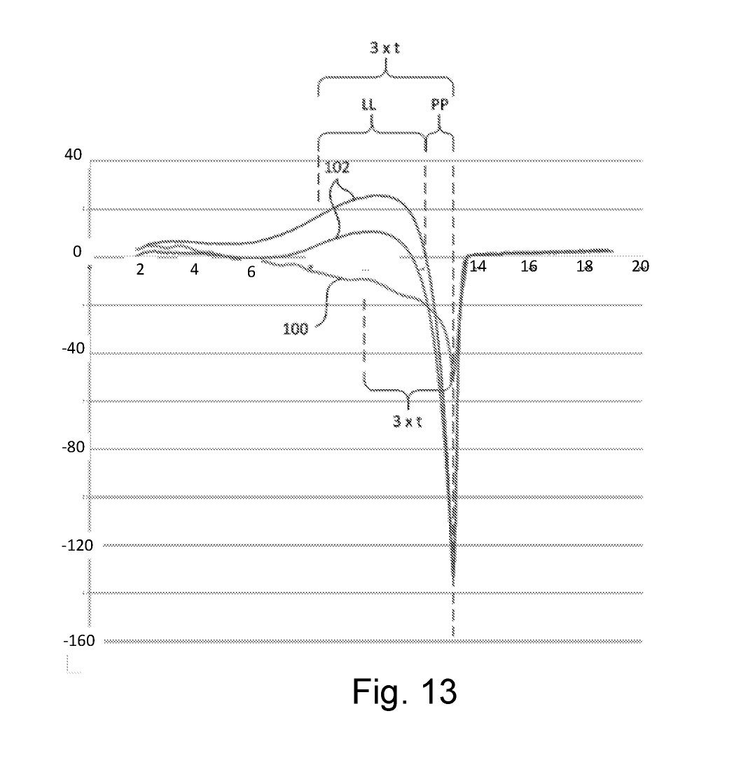

FIG. 13 is a graph of a measured ERP 100 for a glass sheet of thickness 1.1 mm according to the present disclosure, produced according to the methods and equipment of the present disclosure, which was cooled using a porous gas bearing heat sink as described with respect to FIG. 6, along with ERPs 102 for comparative glass sheets of thickness ˜1.7 mm, cooled by forced air convection. The x axis represents position in millimeters; the y axis represents nanometers of retardation. For testing purposes, retardance measurements for ERPs 102 begin at a point 3 times the thickness of the sheet (—1.7 mm in this case) from the edge, represented by the leftmost edge of the upper 3xt bracket, and run to the edge, represented by the rightmost edge of the upper 3xt bracket (or as near to the edge as readings can be obtained, with extrapolation to the edge according to ASTM C1279). For ERP 100, where the thickness t of the sheet is only 1.1 mm, the testing region is indicated by the lower bracket 3xt in the figure.

As seen in the figure, there is a characteristic rise (right-to-left in the figure) of the ERP for the forced air quenched samples, such that the peak value above zero (representing the maximum differential retardation with the slow axis parallel to the outer edge surface 16 of a sheet, defined as LL herein) is a substantial fraction of the absolute value of the peak below zero (representing the maximum differential retardation with the slow axis perpendicular to the outer edge surface 16 of a sheet, defined as PP herein). In terms of the graph, PP is defined as the maximum absolute value below zero within the 3xt region—for the topmost trace, the maximum absolute value within the region marked PP—and LL is defined as the maximum positive value, if any, within the 3xt region—for the topmost trace, the maximum value within the region marked LL. If there is no positive value within the 3xt region—no retardation having a slow axis closer to parallel to the edge than perpendicular—LL is defined as zero.

The ERP 100 of FIG. 13 provides an example in which LL is defined as zero. In embodiments of sheets of the present disclosure having high strength edges, the maximum differential retardation with the slow axis parallel to the outer edge surface 16 of a sheet, if any, is at most 5-10% or 0.05-0.10 times the maximum differential retardation with the slow axis perpendicular to the outer edge surface 16 of a sheet. In the case of what are believed to be particularly high strength edges, as may be seen in ERP 100, which is an ERP of a 1.1 mm sheet cooled in a porous bearing, there is no differential retardation with the slow axis parallel to the outer edge surface 16 (no ERP values above zero) within 3 thicknesses of the outer edge surface of the sheet—within the region indicated by the lower bracket 3xt in the figure. (The edge lies approximately at the negative peak). In this case, LL is defined as zero.

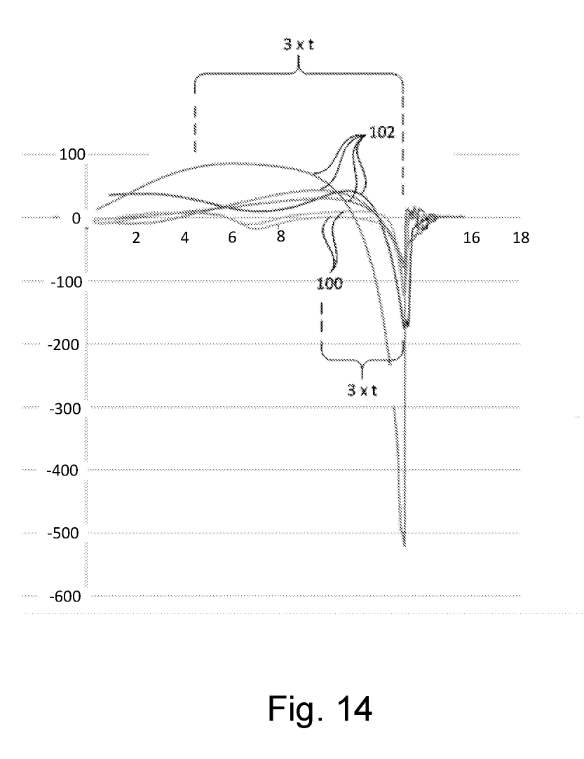

FIG. 14 is a graph of measured ERPs 100 for 1.1 mm sheets according to the present disclosure cooled using a discrete hole gas bearing heat sink Si (such as the heat sink described with respect to FIG. 5 above), and ERPs 102 for comparative 3 mm glass sheets tempered by forced air convection. The testing range of three times the thickness of the sheets is shown by the brackets 3xt above the graph for the ERPs 102 and below for the ERPs 100. Although the contrast in the rise of the ERPs is not as great as in FIG. 13, the ERPs 100 again demonstrate a higher strength edge than the ERPs 102. In embodiments of the present disclosure, the maximum differential retardation with the slow axis parallel to the outer edge surface 16 of a sheet, if any, is at most 5-10% or 0.05-0.10 times the maximum differential retardation with the slow axis perpendicular to the outer edge surface 16 of a sheet, with values of 0.04, 0.03,3 0.02, 0.01, even 0.001 or (defined) zero, achievable.

As noted, when measuring ERPs for the comparative edge strength determinations described above, it is sometimes necessary to estimate (extrapolate) the retardance at the ultimate edge of the sheet in cases where edge shape and/or optical quality do not permit retardance measurement up to the edge. For purposes of ERP measurement as described herein, this is done in accordance with ASTM C1279.

A variety of modifications that do not depart from the scope and spirit of the invention will be evident to persons having ordinary skill in the art from the foregoing disclosure.

1. A strengthened glass or glass ceramic sheet comprising
a first major surface;
a second major surface opposite the first major surface;
an interior region located between the first and second major surfaces;
an outer edge surface extending between and surrounding the first and second major surfaces such that the outer edge surface defines the perimeter of the sheet;
a thickness defined as the local distance between the first major surface and the second major surface of the sheet,
wherein the sheet comprises a glass or glass ceramic and is thermally strengthened;
wherein the first major surface has a roughness in the range of from 0.05 to 0.8 nm Ra over an area of 10 μm×10 μm; and
wherein PP<0.05·(LL), where LL is defined as the maximum differential optical retardation with a slow axis closer to perpendicular than to parallel to the outer edge of the sheet, PP is defined as the maximum differential optical retardation with a slow axis closer to parallel than to perpendicular to the outer edge of the sheet, if any, otherwise zero, with both PP and LL measured through the sheet through the first and second major surfaces beginning at a location 3 thicknesses of the sheet distant from the outer edge surface of the sheet and moving by steps 1/100 of the thickness of the sheet to the outer edge surface of the sheet, with the value of LL including an extrapolation of the maximum retardation at the outer edge surface of the sheet according to ASTM C1279.

2. The sheet according to claim 1 wherein PP≤0.03·(LL).

3. The sheet according to claim 1 wherein PP≤0.02·(LL).

4. The sheet according to claim 1 wherein PP≤0.01·(LL).

5. The sheet according to claim 1 wherein PP≤0.001·(LL).

4. The sheet according to claim 1 wherein PP≤0.01·(LL).

5. The sheet according to claim 1 wherein PP≤0.001·(LL).

6. The sheet according to claim 1 wherein the first major surface has a roughness of more than 0.05 nm Ra and less than 0.7 nm Ra over an area of 10 μm×10 μm.

7. The sheet according to claim 1 wherein the first major surface has a roughness of more than 0.05 nm Ra and less than 0.6 nm Ra over an area of 10 μm×10 μm.

8. The sheet according to claim 1 wherein the first major surface has a roughness of more than 0.05 nm Ra and less than 0.5 nm Ra over an area of 10 μm×10 μm.

9. The sheet according to claim 1 wherein the first major surface has a roughness of more than 0.05 nm Ra and less than 0.4 nm Ra over an area of 10 μm×10 μm.

10. The sheet according to claim 1 wherein the first major surface has a roughness of more than 0.05 nm Ra and less than 0.3 nm Ra over an area of 10 μm×10 μm.

11. The sheet according to claim 1 wherein the first major surface has a roughness of more than 0.05 nm Ra and less than 0.2 nm Ra over an area of 10 μm×10 μm.

12. The sheet according to any of claims 1-11 wherein the sheet has a thickness in the range of from 0.2 to 3 mm.

13. The sheet according to any of claims 1-11 wherein the sheet has a thickness in the range of from 0.2 to 1.6 mm.

6. The sheet according to claim 1 wherein the first major surface has a roughness of more than 0.05 nm Ra and less than 0.7 nm Ra over an area of 10 μm×10 μm.

7. The sheet according to claim 1 wherein the first major surface has a roughness of more than 0.05 nm Ra and less than 0.6 nm Ra over an area of 10 μm×10 μm.

8. The sheet according to claim 1 wherein the first major surface has a roughness of more than 0.05 nm Ra and less than 0.5 nm Ra over an area of 10 μm×10 μm.

9. The sheet according to claim 1 wherein the first major surface has a roughness of more than 0.05 nm Ra and less than 0.4 nm Ra over an area of 10 μm×10 μm.

10. The sheet according to claim 1 wherein the first major surface has a roughness of more than 0.05 nm Ra and less than 0.3 nm Ra over an area of 10 μm×10 μm.

11. The sheet according to claim 1 wherein the first major surface has a roughness of more than 0.05 nm Ra and less than 0.2 nm Ra over an area of 10 μm×10 μm.

12. The sheet according to claim 1 wherein the sheet has a thickness in the range of from 0.2 to 3 mm.

13. The sheet according to claim 1 wherein the sheet has a thickness in the range of from 0.2 to 1.6 mm.

14. The sheet according to claim 1 wherein the sheet has a thickness in the range of from 0.2 to 1.2 mm.

15. The sheet according to claim 1 wherein the sheet has a thickness in the range of from 0.2 to 1.1 mm.

16. The sheet according to claim 1 wherein the sheet has a thickness in the range of from 0.2 to 1 mm.

17. The sheet according to claim 1 wherein the sheet has a thickness in the range of from 0.2 to 0.9 mm.

18. The sheet according to claim 1 wherein the sheet has a thickness in the range of from 0,2 to 0.8 mm.

19. The sheet according to claim 1 wherein the sheet has a thickness in the range of from 0.2 to 0.7 mm.

20. The sheet according to claim 1 wherein the sheet comprises soda lime glass.
